(19) United States
(12) Patent Application Publication
(10) Pub. No.: US 2026/0329881 A1
(43) Pub. Date: Oct. 22, 2026

(54) SYSTEMS AND METHODS FOR DATABASE DELTA AUTOMATION

(71) Applicant: ServiceNow, Inc., Santa Clara, CA (US)

(72) Inventors: Max Qiwen Lei, Newcastle, WA (US); Jacob Roland Lindstrom, Seattle, WA (US); Brian James Linnenkamp, Renton, WA (US); Suvarna Patil, Issaquah, WA (US); Demietrich Baker, Seattle, WA (US)

(21) Appl. No.: 19/723,688

(22) Filed: Jun. 29, 2026

Related U.S. Application Data
(63) Continuation of application No. 16/917,371, filed on Jun. 30, 2020.

(51) Int. Cl. G06F 16/25; G06F 9/48; G06F 9/50; H04L 9/40; H04L 67/63

(52) U.S. Cl. CPC G06F 16/252; G06F 9/4881; G06F 9/5083; H04L 63/1416; H04L 67/63

(57) ABSTRACT

The present disclosure relates generally to a system and method for the derivation of deltas. In certain embodiments, a configuration management database (CMDB) is configured to store configuration item (CI) information. One or more templates are also provided. The one or more templates are communicatively coupled to the CMDB and executable via a processor, wherein the one or more templates are configured to derive a delta comprising a difference in hosts between a first list of hosts stored in the CI information and a second list of hosts stored in an external database, wherein the external database is communicatively coupled to an external system external to the CMDB and is configured to store the second list of hosts provided via the external system.

### CROSS-REFERENCE TO RELATED APPLICATIONS

This application claims priority to and the benefit of U.S. patent application Ser. No. 16/917,371, entitled “SYSTEMS AND METHODS FOR DATABASE DELTA AUTOMATION,” filed Jun. 30, 2020, which is hereby incorporated by reference in its entirety for all purposes.

### BACKGROUND

The present disclosure relates generally to database systems, and more specifically, to database system changes or deltas.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates generally to a system and method for derivation of deltas or differences between cloud-based database systems. Certain cloud-based systems may be embodied in a multi-instance or multi-tenant framework, and may provide for certain computing systems and issue tracking (e.g., configuration item (CI) issue tracking). Other cloud-based systems may provide for vulnerability information scanning and for vulnerability management. For example, a first cloud-based system may track CIs such as virtual machines, databases, networks, instances (e.g., server instances, database instances), gateways, firewalls, and so on. In one example, the first cloud-based system may be a ServiceNow® cloud available from ServiceNow® Inc., of Santa Clara, California, U.S.A. A second cloud-based system may be used to scan for vulnerabilities in the CIs, such as a Tenable® vulnerability scanning system available from Tenable®, Inc. of Columbia, Maryland, U.S.A., while a third cloud-based system may be used to manage vulnerabilities, such as a Qualys® vulnerability management system available from Qualys® Inc. of Foster City, California, U.S.A. During use, the issue tracking system may provide for CI information while the vulnerability scanning system may scan for vulnerabilities in the various CIs. The vulnerability management system may aid in managing, for example, risks due to vulnerabilities that may be found. Unfortunately, there may be differences in information found in the databases of each of the three cloud-based systems. For example, the vulnerability scanner may discover new CIs during a scan that may not be found in the issue tracking system, or may find that certain CIs listed in the issue tracking system are no longer found. Likewise, similar discrepancies may be found in the vulnerability management system. Indeed, discrepancies (e.g., CIs not listed and/or CIs listed but not present) may be found between all three cloud-based systems. It may be beneficial to synchronize between multiple cloud-based systems, for example, to maintain information consistency and improve management of CIs. Accordingly, the techniques described herein may discover and respond to database inconsistencies, as further described below.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance of FIG. 2, in which embodiments of the present disclosure may operate;

FIG. 5. is a screenshot of an embodiment of a visual programming system that may be used to create and/or modify certain templates for the derivation of deltas, in accordance with aspects of the present disclosure;

FIG. 6 is a flowchart depicting an embodiment of a process suitable for deriving deltas, in accordance with aspects of the present disclosure;

FIG. 7 is a screenshot depicting an embodiment of a visual template suitable for deriving a list of hosts from an external system, in accordance with aspects of the present disclosure;

FIG. 8 is a screenshot illustrating an embodiment of a visual template suitable for deriving a list of hosts from an external system that uses a credentialing technique, in accordance with aspects of the present disclosure;

FIG. 9 is a screenshot of an embodiment of a visual template suitable for verifying deltas, in accordance with aspects of the present disclosure;

FIG. 10 is a screenshot of an embodiment of a visual template suitable for processing hosts in parallel, in accordance with aspects of the present disclosure; and

FIG. 11 is a block diagram of embodiments of one or more nodes that may execute visual templates for verifying deltas, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As used herein, the term “configuration item” or “CI” may refer to a record for any component (e.g., computer, device, piece of software, database table, script, webpage, piece of metadata, and so forth) in an enterprise network, for which relevant data, such as manufacturer, vendor, location, or similar data, is stored in a configuration management database (CMDB). The CI information may include “hosts”, such as computing systems including servers, virtual servers, workstations, laptops, tablets, cell phones, mobile devices, and the like. The CMDB may store interdependencies between the hosts, applications executable by the hosts, hardware used by the hosts, or a combination thereof, and may be used to visualize the interdependencies. As used herein, a “service” may refer to a group of interrelated CIs that may cooperate to perform an overall function, such as a backup service, a data migration service, a virus scanning service, etc. As used herein, the term “delta” may refer to a difference between two or more databases, such as a CI that is listed in a database of a first cloud-based system but not in a database of a second cloud-based system, or vice versa.

As used herein, the term “flow” may refer to data processing of information (e.g., database records) that may be presented to a user in a flow chart-like view. A flow may have inputs but may or may not have an output. A flow may include one or more “sub-flows” and/or one or more “Actions.” The flow may also include “triggers” and control logic. A “sub-flow” as used herein may refer to data processing of information (e.g., database records) also presented to the user in a flow chart-like view. Unlike the flow, a sub-flow may have both inputs and outputs. A sub-flow may additionally contain Actions, triggers, control logic and/or other sub-flows. A “trigger” may be “fired” or turned on by a change in certain conditions, such as a change in one or more database records. The trigger may also be “fired” or otherwise turned on via a schedule, e.g., daily, weekly, monthly schedule. “Action” as used herein may include one or more “Steps.” Steps may be self-contained code, such as scripts (e.g., Java, JavaScript code) provided by the manufacturer of the software tools used to create the flows, sub-flows, and the like. Steps may also be provided by users and any other entity. As used herein, the terms “flow objects” may refer to flows, sub-flows, Actions, and Steps.

The present disclosure relates generally to systems and methods for deriving deltas between two or more database systems, each of which may, though does not necessarily, reside in a different cloud-based environment. The derivation of the deltas may include executing one or more flow-based processes via a visual programming tool that provides for the creation of software without typing in computer code, such as Flow Designer™ available from ServiceNow® Inc., of Santa Clara, California, U.S.A. The visual programming system may be used by non-technical personnel, among others, to develop code. For example, the visual programming system may enable the non-technical personnel to use natural language to more easily create and visualize objects and flows that automate certain tasks. Indeed, information flow objects may be created without typing or otherwise entering text in a programming language.

In certain embodiments, an issue tracking system (e.g., CI issue tracking system) may be operatively coupled to the visual programming system that executes one or more customizable flows or visual programs that may be customized to derive the deltas from various external systems, e.g., a vulnerability scanning system and/or a vulnerability management system. The derivation of the deltas may include deriving a list of one or more CI hosts found in one of the system's databases but not in another. The flows may then initiate certain techniques, such as ping requests, discovery requests, and the like, to verify the existence of the unlisted hosts. The host list(s) may then be used to automatically create and/or track certain problem resolution (PRB) issue requests, which may be used to resolve the deltas.

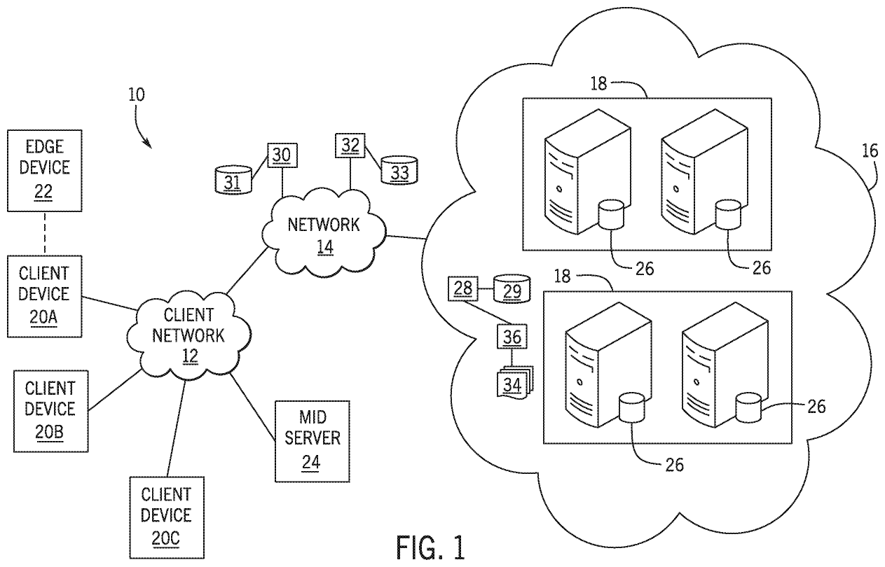

With the preceding in mind, the following figures relate to various types of generalized system architectures or configurations that may be employed to provide services to an organization accessing a cloud-platform, such as may be embodied in a multi-instance or multi-tenant framework on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 in which embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) that includes a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, in order to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary Java® Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

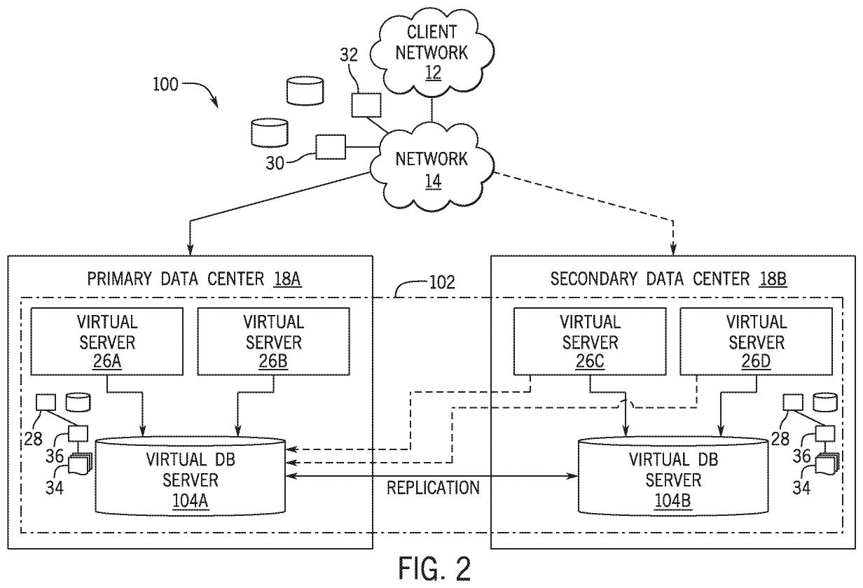

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

It would be beneficial to provide for derivations of deltas in databases such as between databases 29, 31, and 33 which may be used by an issue tracking system 28, a vulnerability scanning system 30, and/or a vulnerability management system 32. The deltas may include hosts listed in one of the databases but not in one or more of the others. Accordingly, a set of customizable and reusable templates 34 may be provided, executable via a visual programming system 36, that may be used to derive deltas between the issue tracking system 28, the vulnerability scanning system 30, and/or the vulnerability management system 32. In one embodiment, the templates 34 may be preconfigured for certain specific systems, such as when the issue tracking system 28 is part of the ServiceNow® cloud, the vulnerability scanning system 30 is the Tenable® vulnerability scanning system, and the vulnerability management system is the Qualys® vulnerability management system. The templates 34 may be customizable, so that the templates 34 may be adapted to a variety of other systems.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

In the depicted embodiment, the issue tracking system 28 may provide for management of, for example, information technology issues (e.g., bugs) and developer resources allocated to the issues. That is, the issue tracking system 28 may store a list of virtual machines instances, networks, subnetworks, drives, databases, applications, cost centers, users, assets, hardware, and so on, and issues associated with each, for example, in the database 29 (e.g., CMDB). Issue information may include further details specific to each resource type, e.g., for virtual machines it may include memory allocated, number of processors, type of processors, and so on. The issue tracking system 28 may be included in the virtual server 26 and/or manage CIs for the virtual server 26. For example, the issue tracking system 28 may provide for tables of issues and related resources, and may be available from ServiceNow® Inc., of Santa Clara, California, U.S.A, for example, as part of a service management system.

The issue tracking system 28 may be communicatively coupled to the vulnerability scanning system 30, and/or to the vulnerability management system 32. In use, the issue tracking system 28 may store a list of CIs and issues related to the CIs in the database 29 (e.g., CMDB). The vulnerability scanning system 30 may scan, for example, various CIs for vulnerabilities and store a scan vulnerability list containing, for example, older versions of software, open ports, vulnerable software, vulnerable hardware, and so on found for the CIs, in the database 31. Likewise, the vulnerability management system 32 may store a second vulnerability list for the CIs in the database 33.

Users may add or remove certain hosts or other systems tracked by the CIs (e.g., servers, applications, networking equipment, and so on) and may not update all of the databases 29, 31, 33 used by the issue tracking system 28, the vulnerability scanning system 30, and/or to the vulnerability management system 32. Likewise, certain CIs may become inoperative and thus may no longer be part of a system or an organization, and updates reflecting the changes to all three databases may not occur. Accordingly, hosts or other systems tracked as a CI may now be listed in a database but it may either not exist or it may exist but it may not be listed in all three systems 28, 30, 32. Accordingly, the issue tracking system 28 may execute certain delta derivation processes, as further described below, to discover differences between the databases used by the issue tracking system 28, the vulnerability scanning system 30, and/or to the vulnerability management system 32. In the illustrated embodiment, the processes used to derive the deltas may be implemented as visual computer program templates 34 executable in the visual programming system 36. It is to be noted that, in other embodiments, the processes used to derive the deltas may be implemented in any type of computer code or instructions executable via processors (e.g., microprocessors).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

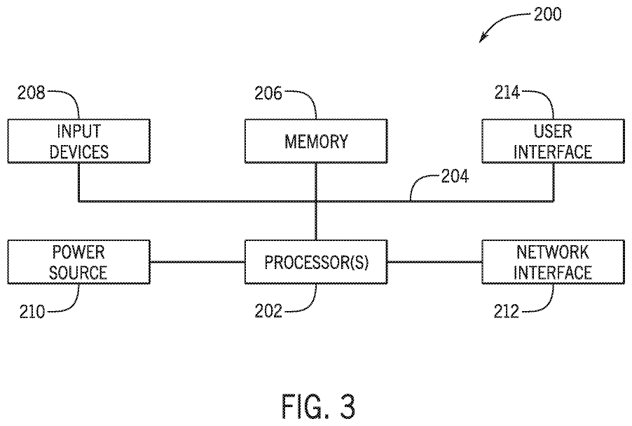

With this in mind, and by way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

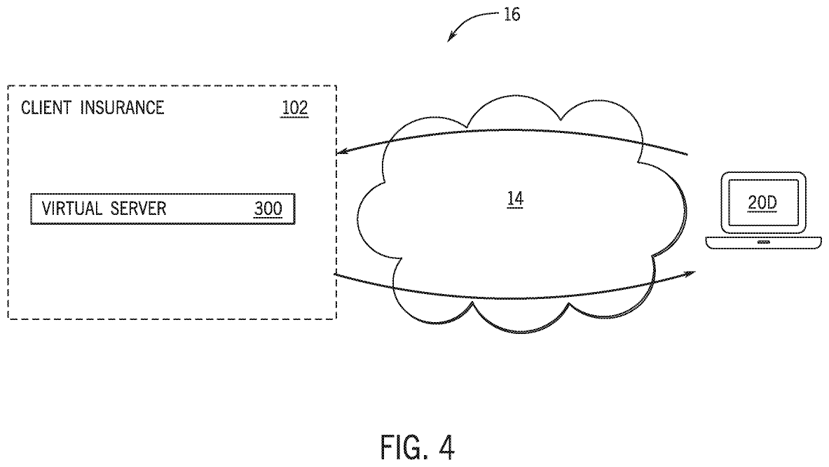

FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

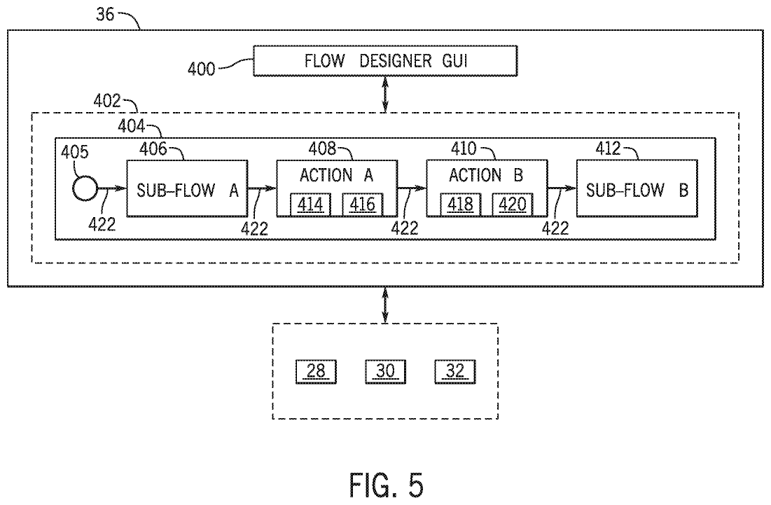

FIG. 5 is a screenshot depicting an embodiment of the visual programming system 36 which may include a flow designer graphical user interface (GUI) 400 suitable for inputting certain flow objects 402 into a flow, such as a flow 404. The flow designer GUI 400 may be used to create the reconfigurable and reusable templates 34, for example, by visually presenting a variety of flow objects and flow logic (e.g., Boolean logic) and by enabling the user to move (e.g., via a mouse) the flow objects and flow logic as desired. Indeed, the flow designer GUI 400 may be used to create and edit any number of graphical flow views that may then be executed as flow objects 402 without typing computer code, thus enabling a visual flowchart approach to creating software.

In the depicted embodiment, a trigger 405 initiates execution of a sub-flow 406. The sub-flow 406 may include Actions, control logic (e.g., Boolean logic, branching logic, termination logic), other sub-flows, and so on. The sub-flow 406 may additionally take in inputs and provide outputs. For example, output of the sub-flow 406 may be used as input to the Action 408. The Action 408 may use the inputs provided to execute Steps 414, 416. The Action 408 may also include control logic. Steps, such as the Steps 414, 416, and may be self-contained code, such as scripts (e.g., Java, JavaScript code) provided by the manufacturer of the flow designer system 112. As an example, the visual programming system 36 may be provided by ServiceNow® Inc., of Santa Clara, California, U.S.A., under the name Flow Designer™. The Steps 414, 416 may be additionally or alternatively provided by other third parties and/or coded by certain users, such as IT users.

Steps may include any number of functionalities, such as login into the external systems 30, 32, executing application programming interface (APIs) calls to the external systems 30, 32, querying records in a database table, editing the record in the database table, deleting the records in the database table, creating server tasks, logging messages, looking up database information, notifying of certain events (e.g., incidents, change requests, problems, changes to user records), executing scripts, such as JavaScript, sending email, waiting for a condition to occur, and so on. Action 410 may execute following Action 408. In turn, Action 410 may include Steps 418, 420, and upon completion of Step 420, sub-flow 412 may be executed. Once sub-flow 412 finishes execution, the flow 404 finishes. Flows, such as the flow 404, may or may not have outputs. Programming flow from one action or subflow to the next may be provided by visual arrows, such as arrows 422. Accordingly, a user may create a flowchart-like flow 404, which may then be executable by a processor. The GUI 400 may enable the user to change or otherwise reconfigure the templates 34, for example, by changing the properties of the objects in the templates 34, changing program flow, and so on, without typing computer code. The flows may be executable from external clients, such as a clients coupled to the client network 12 shown in FIG. 1.

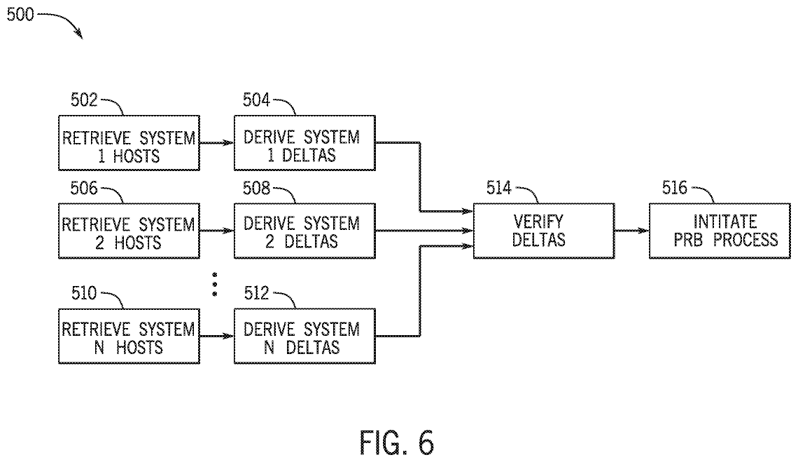

Turning now to FIG. 6, the figure is a flowchart illustrating an embodiment of a process 500 suitable for deriving deltas, such as differences in hosts known to the issue tracking system 28 and to one or more external systems, such as the vulnerability scanning system 30 and the vulnerability management system 32. The process 500 may be implemented as computer code or instructions executable by the one or more processors 202 and stored in the memory 206. For example, the process 500 may be implemented as the templates 34 via the visual programming tool 36. In the depicted embodiment, the process 500 may retrieve (block 502) a list of hosts from a first external system (e.g., the vulnerability scanning system 30). For example, a template 34 may include a flow suitable for retrieving a list of internet protocol addresses for various hosts. Hosts may include systems that may be scanned for vulnerabilities, such as servers, including virtual servers, networking equipment, client computers, tablets, notepads, mobile devices, and so on.

The process 500 may then derive (block 504) deltas between the issue tracking system's database (e.g., CMDB) and the first external system's database (e.g., database used by the vulnerability scanning system 30). Further details of the derivation (block 504) of the deltas for the first external system is described below. In a similar manner, the process 500 may also retrieve (block 506) a list of hosts for a second external system (e.g., vulnerability management system 32), and process the list of hosts to derive (block 508) deltas for second external system. By retrieving a list of hosts (block 510) and subsequently deriving (block 512) deltas based on the list of hosts, N number of external systems may be processed.

The process 500 may then verify (block 514) the deltas. For example, pings and/or reverse domain name service (DNS) lookups may be used to verify that a host exists. Pinging the host may return a ping reply, thus verifying the existence of the host. Likewise, an internet protocol address (IP) may be entered into a reverse DNS lookup system to see if the IP is found. Other verification (block 514) techniques may include using trace routing (tracert command), whois lookups, and so on. The process 500 may then initiate (block 516) a problem (PRB) resolution process, for example, by creating a virtual PRB ticket via the issue tracking system 28. The issue tracking system 28 may then be used, for example, to resolve the deltas via a PRB ticket resolution process. For example, information technology (IT) personnel may be notified via the PRB ticket to resolve deltas, such as hosts that exist but are not listed in one of the databases 29, 31, 33, and to update the resolution steps as further actions taken.

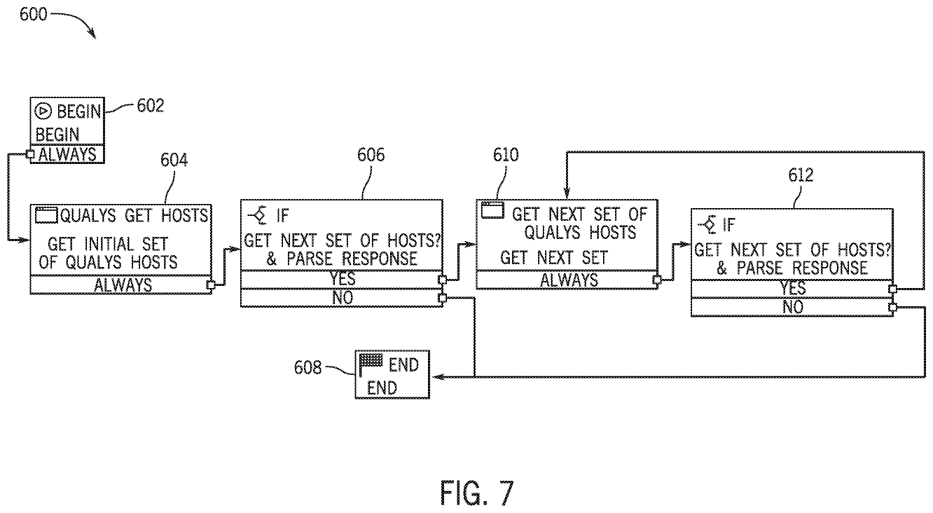

It may be beneficial to illustrate example templates 34 implemented as visual flows via the visual programing system 36 that may be used to implement portions (or all) of the process 500. Accordingly, FIGS. 7-10 depict various visual flows that may be used to implement the techniques described herein. Turning now to FIG. 7, the figure is a screenshot illustrating an embodiment of a flow 600 executable via the visual programming system 36 that may be used to implement, for example, a process for retrieving a host list from an external system, such as from the vulnerability management system 32. In the depicted embodiment, a Begin action 602 may start the flow 600, and a “Get Hosts” action 604 may then interface with the external system (e.g., vulnerability management system 32). The action 604 may include steps that interface with the external system via the external system's API and then ask the external system (e.g., via a method, function call, and the like) to provide for an initial list of hosts. In some embodiments, the API call may include using a representational state transfer (REST) message to perform a hypertext transfer protocol (HTTP) GET call on an endpoint provided by the external system.

The flow 600 may then parse, via a logic block 606, a response from the external system. For example, the block 606 may check certain codes returned by the external system to see if more data is available, as certain external systems may send only a maximum number of data records per call to more efficiently communicate data. Records communicated may be parsed to retrieve an IP address, a hostname, an operating system, and so on, for each host, and the parsed data may then be stored for later processing. If there are no more data records to communicate the flow 600 may then end via a stop block 608. If there are more records to communicate the flow 600 may then execute action 610 to get the next block of records and subsequently apply a logic block 612 to parse the records communicated as well as to check if more records are to be communicated. Parsing (block 612) may include retrieving an IP address, a hostname, an operating system, and so on, for each host, and then storing the parsed data for later processing. If no more records are to be communicated the flow may stop (block 608).

The flow 600 may be provide as one of the templates 34, and may be reconfigurable and reusable. For example, a user may open the flow 600 via the GUI 400 and then edit certain information (e.g., connection information, login information, a number of records to communicate, and so on) and thus customize the flow 600 for their specific uses. The flow 600 may also be shared, for example, via an application (e.g., app) store and then reconfigured for the specific use without having to reprogram or otherwise recompile a traditional computer program.

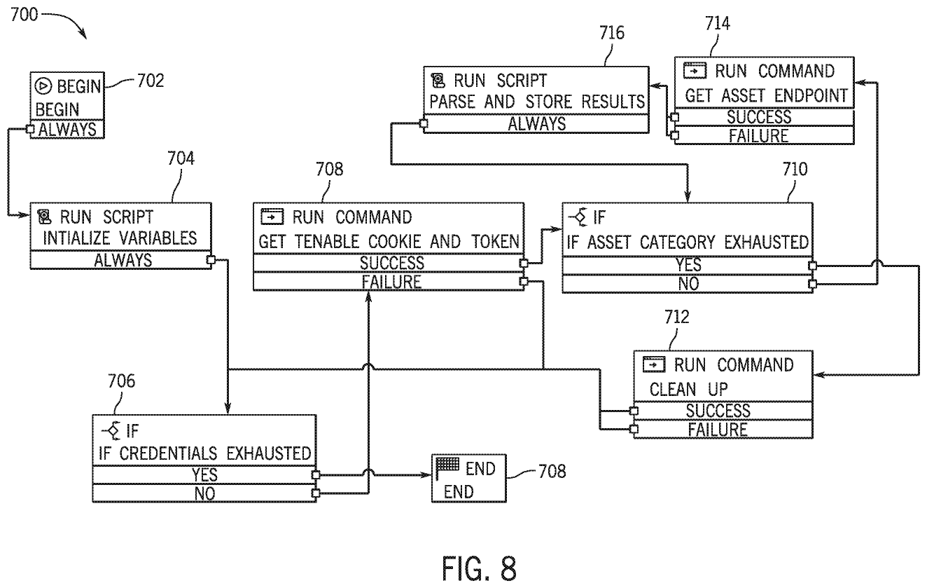

FIG. 8 is a screenshot illustrating an embodiment of a flow 700 executable via the visual programming system 36 that may be used to implement, for example, a process for retrieving a host list from another external system, such as from the vulnerability scanning system 30. In the depicted embodiment, the external system being interfaced with includes a credentialing system, such as a token-based credentialing system. The flow 700 may initiate execution via a begin action 702, and then initialize, via action 704, one or more variables. The initialized variables may be used, for example, to initialize certain credentials and/or token data, as well as other variables that may be used later in the flow 700. Credentials may include reusable objects to facilitate logins, for example, database credentials to log into databases, simple network management protocol (SNMP) credentials to log to equipment supporting SNMP, secure shell (SSH) credentials to log into systems via SSH, Microsoft Windows® credentials to log into Microsoft Windows® domains, and so on. The credentials may further include reconfigurable information listing authentication techniques to use (e.g., secure socket layer (SSL), security certificates (e.g., OpenSSH, RSA, DSA), private/public keys, and so on), encrypted login/passwords, options to use for specific systems (e.g., MySQL® options, Oracle® options, IBM DB2® options), and the like.

The flow 700 may then check via logic block 706 if the current credentials are exhausted. That is, the logic block 706 may check if there are credentials to be used for querying external systems. If the credentials are exhausted, the flow 700 may then end at end block 708. If there are credentials to use, the flow 700 may select a credential, decrypt the credential and an endpoint corresponding to the credential, and then execute an action 708 to run a command, such as a GET cookie and token command on the endpoint. The action 708 may, for example, use POST on the external system's API (e.g., vulnerability scanning system 30) to GET the cookie and the token. The cookie may be saved locally (e.g., in the CMDB), and the token may be stored as a variable of the flow 700.

The endpoint may be associated with one or more asset categories (e.g., servers, laptops, tablets, mobile devices, and the like). Accordingly, the flow 700 may then check, via logic block 710, a list of asset categories to see if asset categories for the endpoint are exhausted. If the asset category list is empty, the flow 700 may execute an action 712 to “clean up,” such as removing cookie resources, releasing memory, reinitializing variables, and so on. The flow 700 may then return to block 706 to continue execution of remaining credentials.

If asset categories are still found in the list (block 710), the flow 700 may execute action 714 to GET asset endpoint data. For example, the flow 700 may execute a request via the external system's API by providing cookie and token information in an API call (e.g., “{/asset/{Asset category id}”). The external system 30 may then respond with hostname, IP address, host's operating system, and so on. The flow 700 may then execute action 716 to parse results of the GET and to store the results in the local database (e.g., CMDB), thus deriving a list of hosts via the Asset GETs. The flow 700 may then continue processing the asset category list via block 710. In this manner, a list of hosts known by the external system 30 may be retrieved.

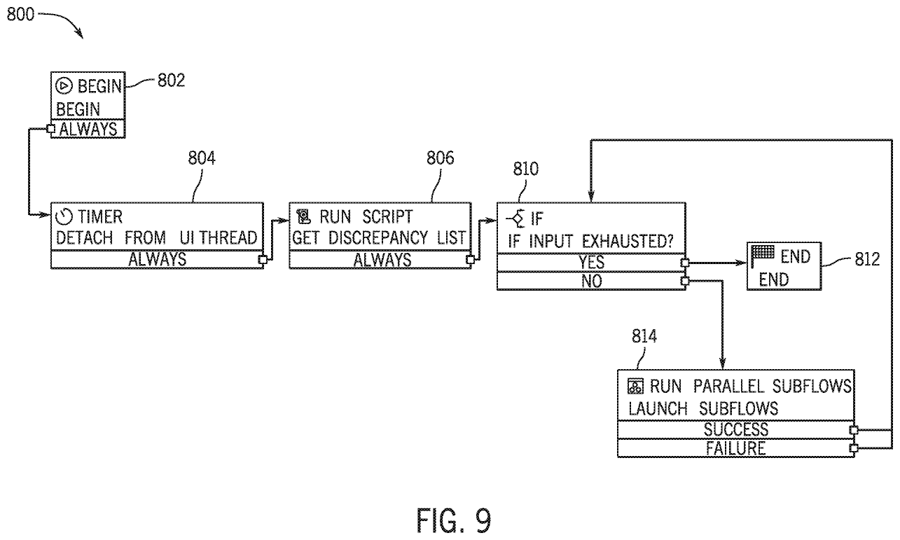

Derivations of deltas may include comparing lists of hosts derived, for example, via the flows 600 and 700. In one embodiment, the CMDB may also include a list of hosts for the issue tracking system 28, and the CMDB's list may then be compared to the lists derived by the flows 600 and 700 to find hosts that are not found in the CMDB but are found in the external systems 30, 32, and/or vice versa. The deltas may then be verified, for example, via a flow described in more detail with respect to FIG. 9.

FIG. 9 is a screenshot illustrating an embodiment of a flow 800 executable via the visual programming system 36 that may be used to implement, for example, a process for verifying deltas found between the databases of the issue tracking system 28, the vulnerability scanning system 30, and the vulnerability management system 32. In the depicted embodiment, the flow 800 may begin execution at action 802 and then execute a timer action 804 detaching further processing from the user interface (UI) thread and wait a specified time for completion of execution of the flow 800 (e.g., explicit time wait such as between 0-45 minutes, relative time wait such as waiting 15 minutes after a specific time, and/or percentage time wait such as a certain percentage of time duration between start of the flow 800 and specified end time).

The flow 800 may then execute an action 806 to run a script that retrieves (e.g., from the CMDB) the deltas or discrepancies. As mentioned earlier, the deltas may include differences in listings of known hosts (e.g., systems that may be scanned for vulnerabilities, such as servers, including virtual servers, networking equipment, client computers, tablets, notepads, mobile devices, and so on) as known by the issue tracking system 28, the vulnerability scanning system 30, and/or the vulnerability management system 32. The flow 800 may the process the deltas via logic block 810. For example, the flow 800 may then process each discrepant host by logic block 810. Logic block 810 may check the list of discrepant hosts and if the list is now exhausted then end the flow via end block 812. If there are hosts to verify the flow 800 may select a certain number of hosts (e.g. between 1 to 20) and process the hosts in parallel. For example, the flow 800 may run parallel subflows at block 814, and after the subflows have completed execution, return to block 810 to check for remaining hosts in the list, iteratively processing blocks of hosts in parallel.

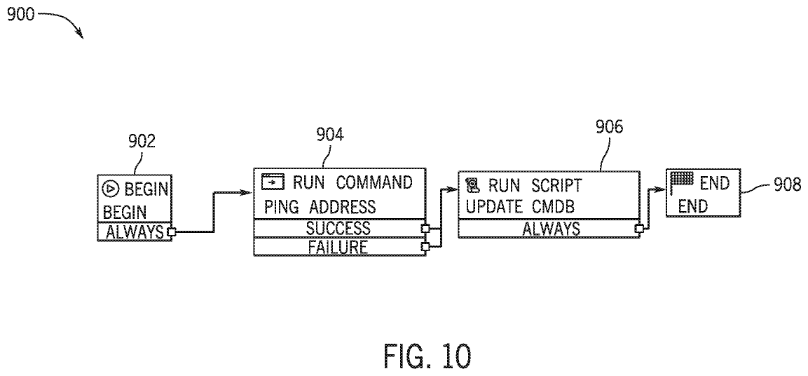

Turning now to FIG. 10, the figure is a screenshot depicting an embodiment of a subflow 900 that may be executed in parallel, such as one the subflow shown being executed in parallel in block 814 of FIG. 9. That is, the subflow 900 may be executed in parallel with other subflows 900 (e.g., each subflow 900 verifying a different host) by the visual programming system 36 during execution of the block 814. In the depicted embodiment, the subflow 900 may begin execution at action 902 and then ping a host's address at action 904. The ping will either result in the host responding or not responding. Accordingly, the subflow 900 may update, via action 906, the issue tracking system's database (CMDB) based on the responses. For example, if the host responds, then the host is shown to exist, while a non-responsive host may not exist. The subflow 900 may then stop execution at block 908. The verified deltas may then be provided to a PRB resolution process, such as block 516 of FIG. 6. As mentioned earlier, the templates 34 may be implemented as flows 600-900. Accordingly, the user may customize the flows 600-900 via the visual programming system 36 to accommodate different computing environments and systems. By providing for a reconfigurable set of templates 34, the techniques described herein may enable a non-programmer to customize the templates a variety of different systems. The customized templates may then be used to find and address deltas between a variety of databases.

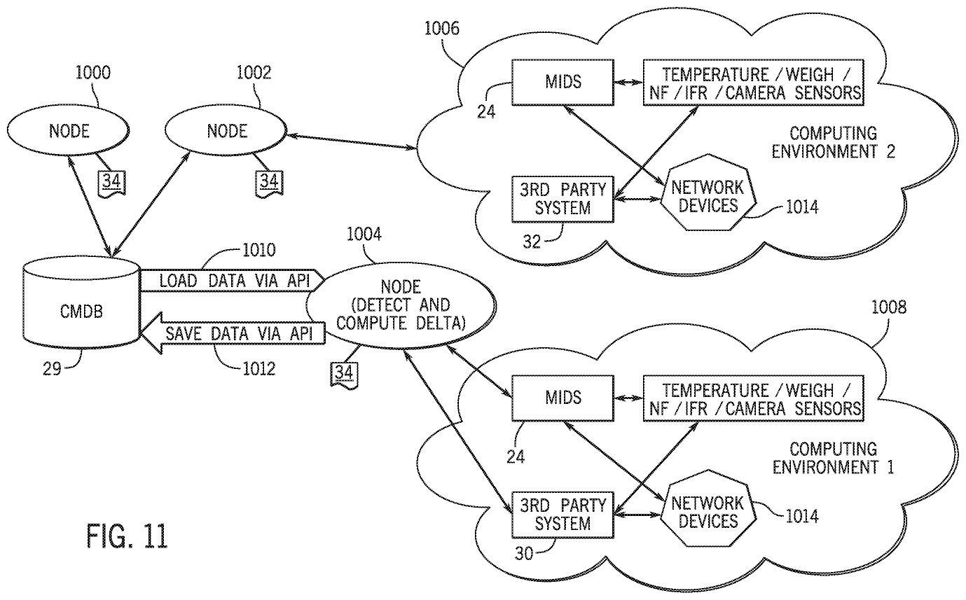

Turning now to FIG. 11, the figure depicts a block diagram depicting embodiments of various nodes 1000, 1002, 1004 that may be communicatively and/or operatively coupled to the CMDB 29. In the depicted embodiment, the nodes 1000, 1002, and/or 1004 may all execute the templates 34, for example, to interface with the systems 30, 32, to scan for vulnerabilities and to manage the vulnerabilities, respectively. In the depicted embodiment, the system 30 is hosted by a first cloud-based environment 1006 and the system 32 is hosted by a second cloud-based environment 1008. As mentioned earlier, each of the systems 28, 30, and/or 32 may be included in a cloud-based system or environment different from each other.

In the depicted embodiment, the nodes 1000, 1002, and 1004 are shown as interfacing with the CMDB 29 via a CMDB API. For example, load data API calls 1010 may be used to load CMDB data, such as a list of CIs stored in the CMDB, while save data API calls 1012 may be used to save, for example, the deltas derived when executing the templates 34. The nodes 1000, 1002, 1004 may also be connected to or be executed by the MID server(s) 24. That is, in one embodiment, MID server(s) 24 may be included in the cloud computing environments 1006, 1008, and the nodes 1000, 1002, 1004 may then interface with or be executed by the MID servers(s) 24 (e.g., the nodes may be included in the MID servers) to execute the templates 34. The MID server(s) 24 and/or the systems 30, 32 may be communicatively coupled to a variety of devices 1014 (e.g., servers, virtual servers, workstations, laptops, tablets, cell phones, mobile devices, and the like). Likewise, the MID server(s) 24 and/or the systems 30, 32 may be communicatively coupled to sensors 1016 used to sense the devices 1014. The sensors 1016 may include temperature sensors, electrical sensors (e.g., power used sensors, amperage used sensors, voltage used sensors), weight sensors, near field (NF), infrared (IFR), camera sensors, and so on, useful in observing the devices. Signals from the sensors 1016 may thus be representative of the devices 1014 operating as usual or operating outside of desired ranges (e.g., too hot, too little power draw, and so on).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
generating a flow designer graphical user interface (GUI) via a visual programing system, the visual programming system operating in a respective cloud-based environment;
receiving a sequence of inputs directed to the flow designer GUI, wherein the sequence of inputs specifies a flow including a plurality of functionalities directed to a first database and a second database;
generating, based on the sequence of inputs, an editable template corresponding to an executable workflow that includes the flow including the plurality of functionalities; and
executing the editable template to determine one or more deltas between the first database and the second database.

2. The method of claim 1, wherein the first database operates in the respective cloud-based environment, and wherein the second database operates external to the respective cloud-based environment.

3. The method of claim 2, wherein the plurality of functionalities includes a first retrieval function to retrieve a first list of hosts stored in the first database and a second retrieval function to retrieve a second list of hosts stored in the second database, and wherein the one or more deltas includes a delta between the first list of hosts and the second list of hosts.

4. The method of claim 3, wherein the second retrieval function includes a call to the second database via an application programming interface (API).

5. The method of claim 1, further comprising:
verifying of the one or more deltas; and
based on the verification, initiating a problem resolution process to resolve the one or more deltas.

6. The method of claim 1, wherein the first database stores identification information regarding configuration items (CIs), and wherein the second database stores vulnerability information regarding the CIs.

7. The method of claim 6, wherein the first database is coupled to an issue tracking system that tracks the CIs to generate the identification information, and wherein the second database is coupled to a vulnerability system that scans or monitors the CIs to generate the vulnerability information.

8. The method of claim 1, wherein the GUI is for display on a client device, and wherein the sequence of inputs is from the client device.

9. The method of claim 1, wherein the sequence of inputs selects flow objects and flow logic associated with the flow objects, and wherein the flow objects and the flow logic together comprise the plurality of functionalities.

10. The method of claim 9, wherein the sequence of inputs includes respective movements, within the GUI, of the flow objects and the flow logic.

11. The method of claim 1, wherein none of the sequence of inputs include providing computer code.

12. The method of claim 1, wherein the sequence of inputs indicates an ordering regarding the plurality of functionalities in the GUI.

13. The method of claim 1, further comprising:
receiving an additional input directed to the flow designer GUI; and
updating the editable template based on the additional input to provide an updated template.

14. The method of claim 13, wherein the additional input comprises a change to connection information associated with the first database, the second database, or both, a change to login information associated with the first database, the second database, or both, a change to a number of records to communicate from the first database, the second database, or both, or any combination thereof, and wherein the method comprises:
executing the updated template to identify additional deltas between the first and second databases based on the change to the connection information, the change to the login information, the change to the number of records to communicate, or any combination thereof.

15. A computing system, comprising:
a configuration management database (CMDB) configured to store a first set of configuration items (CIs); and
a processor communicatively coupled to the CMDB and configured to:
generate a flow designer graphical user interface (GUI) via a visual programming system, wherein the visual programming system is configured to operate in a cloud-based environment;
receive a sequence of inputs directed to the flow designer GUI, wherein the sequence of inputs specifies a flow comprising a plurality of functionalities directed to the CMDB and to an external database configured to store a second set of CIs;
generate, based on the sequence of inputs, an editable template corresponding to an executable workflow that includes the flow comprising the plurality of functionalities; and
executing the editable template to determine one or more deltas between the first set of CIs stored in the CMDB and the second set of CIs stored in the external database.

16. The computing system of claim 15, wherein the processor is configured to: initiate a problem resolution process to resolve the one or more deltas such that the first set of CIs and the second set of CIs each comprise a common set of CIs.

17. The computing system of claim 15, wherein the one or more deltas are indicative of uncommon CIs between the first set of CIs stored in the CMDB and the second set of CIs stored in the external database.

18. The computing system of claim 15, wherein the editable template is configured to validate the first set of CIs and the second set of CIs to determine whether CIs of the first set of CIs or CIs of the second set of CIs are connected to a network system.

19. The computing system of claim 15, wherein the sequence of inputs comprises one or more selectable flow objects and flow logic that collectively define the plurality of functionalities.

20. A non-transitory, computer-readable medium storing instructions executable by a processor of a computing system that is communicatively coupled to a configuration management database (CMDB), the instructions configured to cause the processor to:
generate a flow designer graphical user interface (GUI) via a visual programming system, wherein the visual programming system is configured to operate in a cloud-based environment;
receive a sequence of inputs directed to the flow designer GUI, wherein the sequence of inputs specifies a flow comprising a plurality of functionalities directed to the CMDB and to an external database, wherein the CMDB and the external database are configured to store common configuration item (CI) information;
generate, based on the sequence of inputs, an editable template corresponding to an executable workflow that includes the flow comprising the plurality of functionalities;
execute the editable template to determine one or more deltas between a first set of configuration item (CI) information stored in the CMDB and a second set of configuration item (CI) information stored in the external database.
